(19) United States
(12) Patent Application Publication
(10) Pub. No.: US 2018/0246478 A1
(43) Pub. Date: Aug. 30, 2018

(54) ISOLATION MANAGEMENT SYSTEM AND ISOLATION MANAGEMENT METHOD

(71) Applicants: KABUSHIKI KAISHA TOSHIBA, Minato-Ku (JP); Toshiba Energy Systems & Solutions Corporation, Kawasaki-Shi (JP)

(72) Inventors: Kei TAKAKURA, Yokohama (JP); Susumu NAITO, Yokohama (JP); Hidehiko KURODA, Yokohama (JP); Hiroki SHIBA, Zama (JP)

(73) Assignees: KABUSHIKI KAISHA TOSHIBA, Minato-Ku (JP); Toshiba Energy Systems & Solutions Corporation, Kawasaki-Shi (JP)

(21) Appl. No.: 15/905,237

(22) Filed: Feb. 26, 2018

(30) Foreign Application Priority Data
Feb. 27, 2017 (JP) 2017-034494

(51) Int. Cl. G05B 13/02; G06F 15/18; G06N 3/04

(52) U.S. Cl. CPC G05B 13/027; G06N 3/04; G06F 15/18

(57) ABSTRACT

An isolation management system comprising: a database configured to store information which relates to a plant constructed with a plurality of components, the information comprising a relationship between the plurality of components; a receiver configured to receive designation of a targeted area information defining a target area in the plant; an analyzer configured to analyze a plurality of patterns of respective states of the plurality of components in connection with a changing state of at least one of the plurality of components in the targeted area, based on the information stored in the database; deep learning circuitry configured to extract at least one specific pattern from the plurality of patterns analyzed by the analyzer as an extraction pattern; a plan generator configured to generate a work plan based on the extraction pattern; and an output interface configured to output the work plan generated by the plan generator.

### CROSS-REFERENCE TO RELATED APPLICATION

This application is based upon and claims the benefit of priority from Japanese Patent Application No. 2017-34494, filed on Feb. 27, 2017, the entire contents of which are incorporated herein by reference.

### FIELD

Embodiments described herein relate generally to isolation management technology for managing isolation work of temporarily isolating a target device in a plant during an event in the plant such as construction, maintenance checkup, and/or repair.

### BACKGROUND

Conventionally, prior to isolation work in a plant such as a power plant, a specialized engineer refers to a developed connection diagram indicative of connection relation of respective components and devises a work plan while considering the influence of the isolation work on other components. In order to reduce the labor involved in such isolation work, a technique for automating the work planning for inspecting each bus of the plant has been proposed. Additionally, a technique for extracting the target drawing from design documents has been proposed. Further, a technique for preventing erroneous work at the time of performing the isolation work has also been proposed.

[Patent Document 1] Japanese Unexamined Patent Application Publication No. H6-46528

[Patent Document 2] Japanese Unexamined Patent Application Publication No. 2011-96029

[Patent Document 3] Japanese Unexamined Patent Application Publication No. 2008-181283

In a plant, a large number of components such as various types of devices are installed as a whole. Thus, in the case of devising an isolation work plan by taking all the components into consideration, a huge amount of calculation is required. For instance, when there are 100 devices in the target range and each of those 100 devices has two states of ON/OFF, there are state patterns of 2 to the power of 100 (1×10³⁰ or more). For this reason, it is not efficient to calculate and obtain all the state patterns, and there is a problem that it is not possible to efficiently devise a work plan.

In view of the above-described problem, embodiments of the present invention aim to provide isolation management technology which can efficiently generate a work plan being most suitable for isolation work.

### BRIEF DESCRIPTION OF THE DRAWINGS

In the accompanying drawings:

FIG. 1 is a block diagram illustrating an isolation management system of one embodiment;

FIG. 2 is a schematic diagram illustrating a multilayered neural network;

FIG. 3 is a configuration diagram illustrating a state of a power distribution system before isolation work;

FIG. 4 is a configuration diagram illustrating a state of a power distribution system during isolation work;

FIG. 5 is a flowchart illustrating the first part of isolation management processing;

FIG. 6 is a flowchart illustrating the second part of the isolation management processing subsequent to FIG. 5;

FIG. 7 is a flowchart illustrating the third part of the isolation management processing subsequent to FIG. 5 or FIG. 6;

FIG. 8 is a flowchart illustrating the final part of the isolation management processing subsequent to FIG. 7;

### DETAILED DESCRIPTION

In one embodiment of the present invention, an isolation management system comprises:
a database configured to store information which relates to a plant constructed with a plurality of components, the information comprising a relationship between the plurality of components;
a receiver configured to receive a targeted area information defining a target area in the plant;
an analyzer configured to analyze a plurality of patterns of respective states of the plurality of components in connection with a changing state of at least one of the plurality of components in the targeted area, based on the information stored in the database;
deep learning circuitry configured to extract at least one specific pattern from the plurality of patterns analyzed by the analyzer as an extraction pattern;
a plan generator configured to generate a work plan based on the extraction pattern; and
an output interface configured to output the work plan generated by the plan generator.

In another embodiment of the present invention, isolation management method comprises:
storing information, which relates to a plant constructed with a plurality of components and defines relationship between the plurality of components, in a database;
receiving a targeted area information defining a targeted area in the plant;
analyzing a plurality of patterns of respective states of the plurality of the components in connection with a changing state of at least one of the plurality of components in the targeted area, based on the information stored in the database;
extracting a specific pattern from the plurality of patterns analyzed by the analyzer, as an extraction pattern;
generating a work plan based on the extraction pattern; and
outputting the work plan.

According to embodiments of the present invention provide isolation management technology which can efficiently generate a work plan being most suitable for isolation work.

Hereinbelow, embodiments will be described with reference to the accompanying drawings. First, a plant such as a power plant is configured of plural components such as a power distribution system, a driving device, and a monitoring device. When an event such as construction, maintenance checkup, or repair of a specific device or system is executed in such a plant, it is necessary to minimize the influence of the event on safety of workers and the other devices or systems. Thus, the target device or target system in the event is electrically isolated from the other devices or systems and stopped (powered off). Such work is referred to as isolation.

In the case of devising an isolation work plan in conventional technology, a specialized engineer refers to design documents which includes a single wire connection diagram indicative of connection relation of respective components, an ECWD (elementary control wiring diagram, i.e., a type of developed circuit diagram) indicative of control relation of respective components, an IBD (interlock block diagram), and a soft logic diagram. In view of those documents, the specialized engineer devises an isolation work plan while considering the influence of the isolation work. For instance, when an engineer formulates an isolation plan for a nuclear power plant, it is necessary to investigate thousands to tens of thousands of related documents. Additionally, an engineer needs expertise and extensive experience, and a lot of labor is spent. Further, an alarm informing abnormality occurs due to a mistake of the plan which is attributable to insufficient review or overlooking by an engineer. For the same reason, there is also an event that the operation of the plant stops.

Moreover, there is a predetermined procedure for actual isolation work. When isolation work does not proceed exactly according to this procedure (sequence), an alarm will be issued or an interlock is activated to trigger an event which affects the plant. Thus, as to each device which requires an operation for isolation work, it is necessary for a specialized engineer to evaluate such a device for each procedure by referring to design documents and the state of the plant. This requires a lot of labor. Although there is a method to simulate and evaluate such manually evaluated procedures for each procedure, this simulation method involves a lot of calculation cost.

Further, in the case of planning isolation work, for instance, it is conceivable that a rule is previously provided for a jumper terminal or circuit breaker in order to greatly reduce number of simulation patterns. However, when an isolation pattern is extracted by a simulator, it is not clear whether the extracted isolation pattern is the optimum plan or not. Definition of the above-described “optimum” depends on administrator's management guidelines. For instance, an isolation plan which minimizes exposure dose of workers is supposed as one idea of the optimum isolation plan. Similarly, an isolation plan which minimizes number of work steps (operation time) is supposed as one idea of the optimum isolation plan.

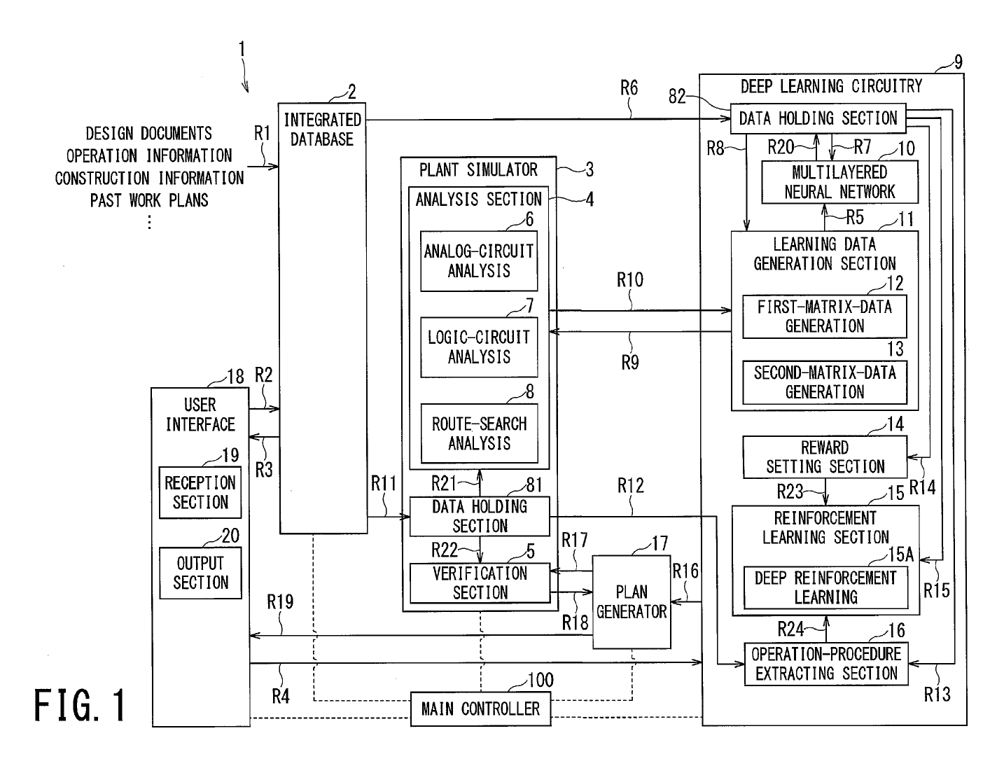

The reference sign 1 in FIG. 1 is an isolation management system 1 which manages a plan of isolation work and automatically generates a work plan. The isolation management system 1 is equipped with an integrated database 2 which stores (a) plant design documents, (b) operation information (i.e., process data), (c) personnel planning information, (d) environmental information, (e) construction information, (f) trouble information, and (g) isolation work plan created in the past. The plant design documents include, e.g., a plant building diagram, a layout diagram, a P&ID, an ECWD, an IBD, a single connection diagram, and a soft logic diagram. The operation information is, e.g., information on an operation state of a plant operation, monitoring, and instrumentation equipment. The Personnel planning information includes, e.g., a construction plan and progress in the plant. The environmental information includes, e.g., radiation dose, temperature, and humidity at each work site in the plant. The construction information is information on workability such as obstacles at the work site, interfering objects at the work site, and work at a place with high altitude. The trouble information is information on the past trouble events, each of which includes its related information such as date, time, place, device name, system name, and construction.

The various type of information items described above are associated with each other on the integrated database 2. In other words, data indicative of various types of information items are structured. Further, the integrated database 2 may be built on a data server provided in the plant or may be built on a server provided in a facility outside the plant. Additionally or alternatively, the integrated database 2 may be built on a cloud server on a network. Moreover, these various types of information item are inputted to the integrated database 2 in advance.

The isolation management system 1 includes a plant simulator 3 that simulates change in influence on other devices or other system(s) in the case of isolating a predetermined device or a predetermined system. The plant simulator 3 includes an analyzing section (i.e., analyzer or any other types of circuitries) 4, a verification section (i.e., verifier or any other types of circuitries) 5, and a data holding section (i.e., database, buffer, memory or any other types of circuitries) 81 that holds various data. The analysis section 4 is used for simulating the plant in the case of generating an isolation work plan. The verification section 5 is used for simulating various changes occurring in the plant when the isolation work is executed in accordance with the generated isolation work plan.

Further, the analysis section 4 includes an analog-circuit analysis circuitry 6 configured to analyze an analog circuit, a logic-circuit analysis circuitry 7 configured to analyze a logic circuit, and a route-search analysis circuitry 8 configured to perform route-search analysis on the basis of, e.g., graph theory. It is also possible to install an arbitrary analysis method (logic) in the analysis section 4 in addition to the above-described three analysis circuitries 6, 7, and 8. When changing a state of a device or a system related to a targeted area (i.e., target site or target portion) of isolation work, the analysis section 4 analyzes change patterns of respective states occurring in other devices or systems on the basis of the information stored in the integrated database 2. The verification section 5 also has the same configuration as the analysis section 4, and verifies the generated work plan on the basis of the information stored in the integrated database 2.

The isolation management system 1 includes deep learning circuitry (e.g., a deep learning unit or a deep learning model) 9 which performs processing related to generation of an isolation work plan on the basis of the data stored in the integrated database 2 and the analysis result of the plant simulator 3. The deep learning circuitry 9 includes a multilayered neural network 10. The plant simulator 3 is a computer which simulates behavior of the plant. The deep learning circuitry 9 is a computer equipped with artificial intelligence which performs machine learning.

The deep learning circuitry 9 includes a learning data generation section (i.e., circuitry) 11 configured to generate learning data which is necessary for constructing the multilayered neural network 10 which has completed learning. The learning data generation section 11 includes a first-matrix-data generation circuitry 12 and a second-matrix-data generation circuitry 13. The first-matrix-data generation circuitry 12 generates the first matrix data in which the state of the first type of device (component) analyzed by the analysis section 4 is treated as its input amount X. The second-matrix-data generation circuitry 13 generates the second matrix data in which the state of the second type of device (component) analyzed by the analysis section 4 is treated as its output amount Y.

The deep learning circuitry 9 further includes a reward setting section (i.e., circuitry) 14 configured to set respective rewards to various types of information items stored in the integrated database 2, a reinforcement learning section (i.e., circuitry) 15 configured to extract the pattern maximizing the value of the isolation plan on the basis of the rewards, and an operation-procedure extracting section (i.e., circuitry) 16 configured to extract the operation procedure (execution order) of the isolation work.

The plant simulator 3 and the deep learning circuitry 9 may be mounted on individual devices or installed in a computer or a server in a facility related to the plant. Additionally or alternatively, the plant simulator 3 and the deep learning circuitry 9 may be installed in a cloud server outside the facility related to the plant.

The isolation management system 1 includes a plan generator 17 configured to generate a work plan on the basis of a predetermined pattern extracted by the deep learning circuitry 9, and further includes a user interface 18 used by an administrator of the isolation management system 1.

The user interface 18 is constituted by, e.g., a personal computer or a tablet terminal in a facility related to a plant. In addition, the user interface 18 includes a reception section (i.e., receiver or input interface) 19 and an output section (i.e., output interface) 20. The reception section 19 receives designation of a place (or area) where a target device (component) to be subjected to isolation work in a plant exists as target area information. The output section 20 outputs the generated work plan. Further, the reception section 19 includes input devices such as a keyboard and a mouse with which the administrator performs input work. Moreover, the output section 20 includes components to be a destination of a work plan such as a display device, a printing device, and a data storage device.

In addition, the isolation management system 1 includes a main controller 100 which integrally controls the integrated database 2, the plant simulator 3, the deep learning circuitry 9, the plan generator 17, and the user interface 18. Further, the deep learning circuitry 9 includes a data holding section (i.e., database, buffer, memory or any other kinds of circuitries) 82 which holds various data.

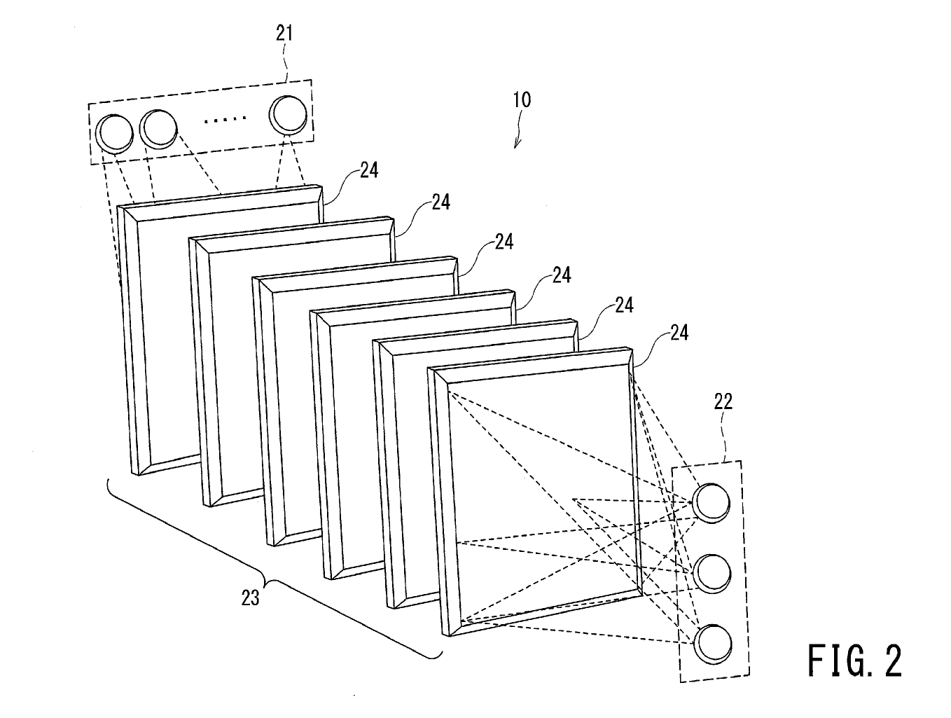

FIG. 2 illustrates one case of the multilayered neural network 10. In this multilayered neural network 10, units are arranged in multiple layers and are connected to each other. Each unit receives multiple inputs U and computes an output Z. The output Z of each unit is expressed as an output of an activation function F of the total input U. The activation function F has weight and bias. The neural network 10 includes an input layer 21, an output layer 22, and at least one intermediate layer 23.

In the present embodiment, the neural network 10 provided with the intermediate layer 23 having six layers 24 is used. Each layer 24 of the intermediate layer 23 is composed of 300 units. By causing the multilayered neural network 10 to learn the learning data in advance, it is possible to automatically extract feature amount in the pattern of a changing state of the circuit or the system. The multilayered neural network 10 can set arbitrary number of intermediate layers, arbitrary number of units, arbitrary learning rate, arbitrary learning number, and an arbitrary activation function on the user interface 18.

The neural network 10 is a mathematical model which expresses characteristics of a brain function by computer simulation. For instance, an artificial neuron (node) which has formed a network by synaptic connection changes synaptic coupling strength by learning, and shows (i.e., constitutes) a model which has acquired problem solving ability. Note that the neural network 10 of the present embodiment acquires the problem solving ability by deep learning.

Next, a description will be given of processes of generating an isolation work plan according to the present embodiment. In the present embodiment, a description will be given of remodeling work of the power-distribution system 25 which constitutes a part of the power supply system in the plant.

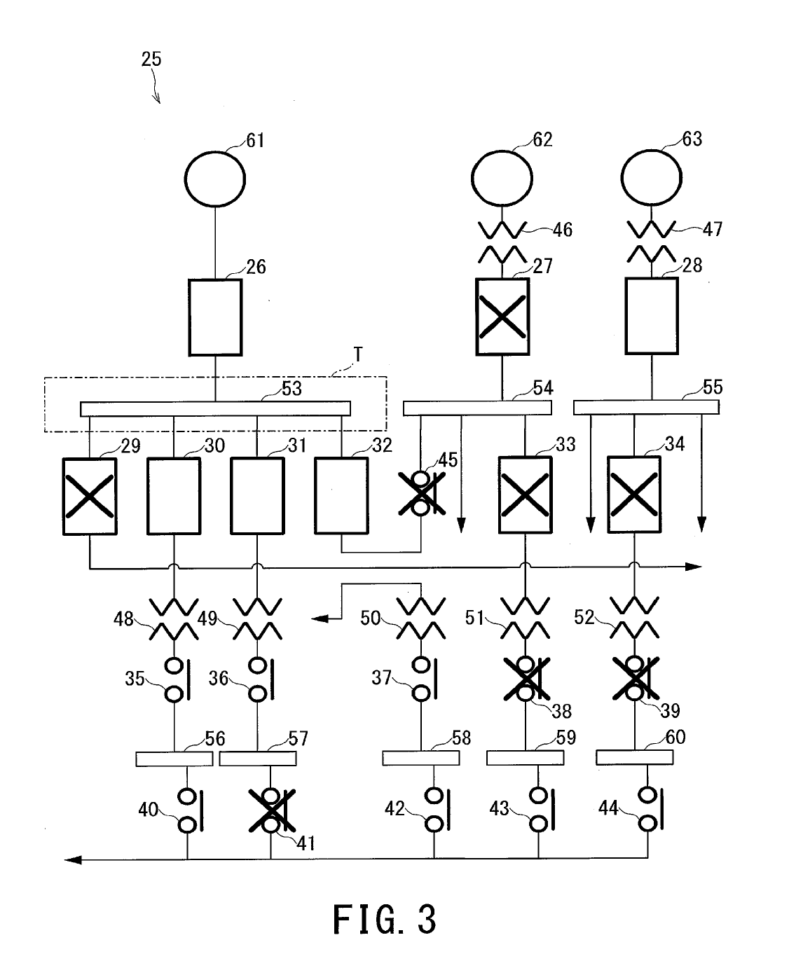

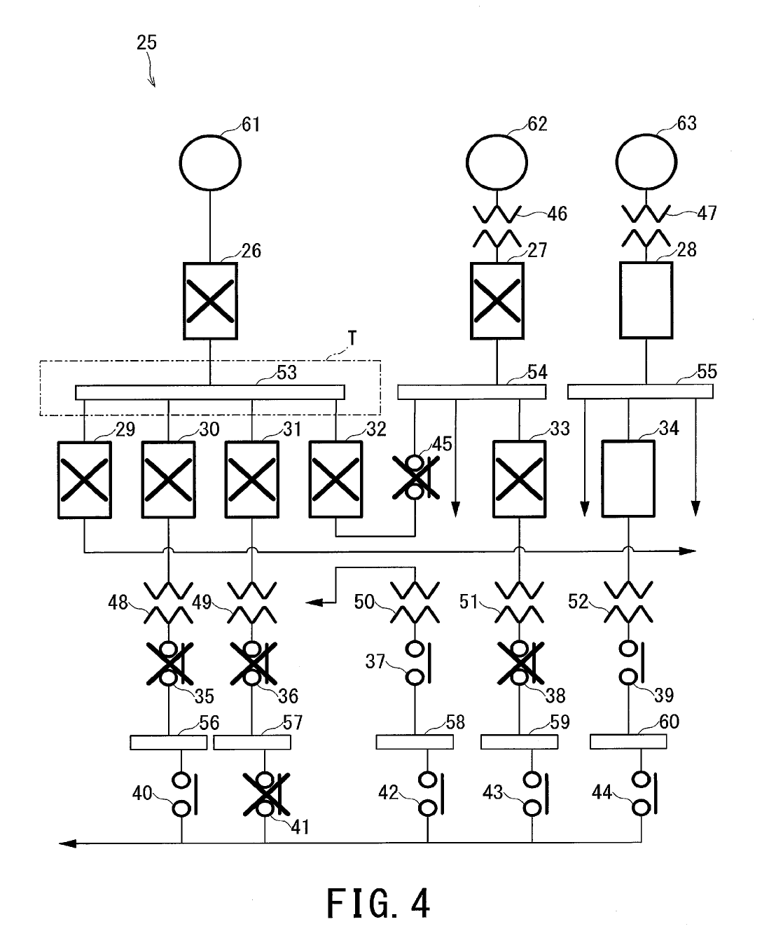

FIG. 3 is a configuration diagram illustrating the state of the power-distribution system 25 before the isolation work. FIG. 4 is a configuration diagram illustrating the state of the power-distribution system 25 during the isolation work. For ease of understanding, circuits of the power-distribution system 25 are simplified in FIG. 3 and FIG. 4.

As shown in FIG. 3 and FIG. 4, the power-distribution system 25 includes plural circuit breakers 26 to 34, plural disconnectors 35 to 45, plural transformers 46 to 52, and plural power-distribution boards 53 to 60. The power-distribution system 25 is constructed by using these components. The circuit breakers 26 to 34 and the disconnectors 35 to 45 constitute the first type of components, and the power-distribution boards 53 to 60 connected to the first type of components constitute the second type of components. Further, plural buses 61 to 63 are provided, and electric power is supplied to the respective devices of the plant from these buses 61 to 63 via the power-distribution boards 53 to 60.

The upper side of the sheet of each of FIG. 3 and FIG. 4 shows components which are on the upstream side and close to the power supply. The lower side of the sheet of each of FIG. 3 and FIG. 4 shows components which are on the downstream side and far from the power supply. In the present embodiment, a case of isolating the power-distribution board 53 from the power-distribution system 25 is illustrated for repairing one predetermined power-distribution boards 53. Out of all the circuit breakers 26 to 34 and the disconnectors 35 to 45 in FIG. 3 and FIG. 4, those marked with “x” are open (i.e., in an insulated state or OFF state) and the rest (i.e., those not marked with “x”) are closed (i.e., in a conductive state or ON state).

In the present embodiment, the power-distribution boards 53 to 55 are respectively connected to the three buses 61 to 63. The power-distribution boards 53 to 55 are connected to the buses 61 to 63 via the circuit breakers 26 to 28 and the transformers 46 and 47. Electric power is supplied to the power-distribution boards 56 to 60 on the further downstream side through the power-distribution boards 53 to 55. The power-distribution boards 53 to 55 on the upstream side are connected to the power-distribution boards 56 to 60 on the downstream side via the circuit breakers 29 to 34, the disconnectors 35 to 39, and the transformers 48, 49, 51, and 52. In addition, the power-distribution boards 56 to 60 on the downstream side are connected to each other via the disconnectors 40 to 44.

Each of the circuit breakers 26 to 34 and the disconnectors 35 to 45 has two states: ON and OFF. Further, each of the power-distribution boards 53 to 60 has two states: operation and stop. In the present embodiment, there are plural state patterns when the state of each of these components is changed. Among these state patterns, the state pattern indicative of the optimum state for isolation is specified. In the following description, the one power-distribution boards 53 to be isolated is appropriately referred to as the power-distribution board 53 of the targeted area T in the present embodiment.

As shown in FIG. 3, prior to the isolation work, electric power is supplied from the predetermined bus 61 to the power-distribution board 53 of the targeted area T. Further, electric power is supplied to the power-distribution boards 56 and 57 on the downstream side via this power-distribution board 53. As to other power-distribution boards, the power-distribution boards 54 is stopped, and the circuit breakers 27, 33 and the disconnector 38 which are connected to this power-distribution board 54 are opened. Another power-distribution board 55 is in operation, but the circuit breaker 34 and the disconnector 39 on the downstream side of this power-distribution board 55 are opened. In other words, electric power is supplied to the five power-distribution boards 56 to 60 on the downstream side through the power-distribution board 53 of the targeted area T.

For instance, in the case of isolating the power-distribution board 53 of the targeted area T, all the circuit breakers 26 and 29 to 32 directly connected to the power-distribution board 53 are opened (the circuit breaker 29 is shown as the open state in FIG. 3) and the disconnector 35 and 36 on the downstream side of the opened circuit breakers 29 to 32 are opened. In this case, electric power supply from the bus 61 is stopped for the power-distribution board 53 of the targeted area T and all the power-distribution boards 56 to 60 on the downstream side. In other words, when the respective states of the circuit breakers 26, 29 to 32 and the disconnectors 35 and 36 are changed with respect to the targeted area T, the states of the respective power-distribution boards 56 to 60 at the other locations change.

Here, it is assumed that there is an operation rule that the particular power-distribution board 56 on the downstream side maintains the energized state. On the basis of this operation rule, when the isolation of the power-distribution board 53 of the target place T is performed, the particular power-distribution board 56 is brought into a power failure state and thus an abnormality warning is issued. As described above, it is required to specify the state pattern of supplying electric power to the particular power-distribution board 56 through another power supply route in such a manner that the pattern of the changing state in each component does not become a pattern in which an abnormality warning is issued.

For instance, a route for supplying electric power from the bus 63 is secured as another power supply route as shown in FIG. 4. Electric power is supplied to the power-distribution board 60 on the downstream side by closing the circuit breaker 34 and the disconnector 39 which are connected to the power-distribution board 55 corresponding to this bus 63. In this manner, electric power is supplied to the particular power-distribution board 56 from the power-distribution board 60. The state shown in FIG. 4 is the specific pattern indicative of the optimum state where isolation is completed.

Incidentally, isolation work includes an operation procedure (order) of predetermined devices. For instance, when there is a particular power-distribution board 56, isolation work is performed after securing another power supply route for this power-distribution board 56. Additionally, after closing the predetermined circuit breaker 34 and disconnector 39, the other circuit breakers 26 to 32 and disconnectors 35 and 36 are opened. Further, when the circuit breakers 30 and 31 and the disconnectors 35 and 36 are connected to each other, the circuit breakers 30 and 31 are opened, and afterward, the respective disconnectors 35 and 36 corresponding to the circuit breakers 30 and 31 are opened.

In the present embodiment, the pattern of the changing state in each component optimum for isolation is automatically extracted by using the plant simulator 3 and the deep learning circuitry 9. First, a description will be given of a case where there is not a model of the multilayered neural network 10 which has completed learning necessary for deep learning.

As shown in FIG. 1, when generating a work plan, the isolation management system 1 first receives targeted area information defining the targeted area T of isolation. Afterward, an administrator performs an input operation for specifying the power-distribution board 53 of the targeted area T by using the user interface 18. When receiving this input operation, the isolation management system 1 acquires data such as design documents related to the device(s) and the system, to which the power-distribution board 53 of the targeted area T is connected, from the integrated database 2.

Further, the isolation management system 1 builds lists of the connection information, the device information, and the attribute information included in the design documents, and incorporates the lists into the analysis section 4 of the plant simulator 3. Moreover, the isolation management system 1 incorporates the process information and the status information of the devices stored in the integrated database 2 (e.g., information indicating whether the respective circuit breakers 26 to 34 are opened or closed) into the analysis section 4.

Here, the analysis section 4 performs simulation on the basis of the lists of the device information, the attribute information, the connection information, and the state information by using the analog-circuit analysis circuitry 6, the logic-circuit analysis circuitry 7, and/or the route-search analysis circuitry 8. Note that one, two, or more of these analysis functions 6, 7, 8 can be combined according to the target circuit or the target system. For instance, it is possible to combine the logic-circuit analysis circuitry 7 and the route-search analysis function 8 in the case of targeting simulation which is composed of an IBD and a system diagram based on a single connection diagram. In this manner, it is possible to simulate the behavior of each component of the plant and the influence on each component of the plant in the case of performing the isolation work.

Additionally, the analysis section 4 outputs the state of each component (device), e.g., the conduction state of the power-distribution board 53 of the targeted area T in the case of separately changing the respective states of all the circuit breakers 26 to 34 and all the disconnectors 35 to 45. There are many patterns of change in the respective states of these components. These patterns of change are transmitted to the learning data generation section 11 of the deep learning circuitry 9.

Further, the learning data generation section 11 treats the attributes or states of the circuit breakers 26 to 34 and the disconnectors 35 to 45 (the first type of components) as the input amount X, and build lists of the attributes or states of the power-distribution boards 53 to 60 (the second type of components) as the output amount Y. Note that the attributes or states of the first type of components and the second type of components are outputted from the analysis section 4.

The first-matrix-data generation function 12 of the learning data generation section 11 expresses the state (i.e., open state or blocked state) of each of the circuit breakers 26 to 34 and disconnectors 35 to 45 as 0 or 1, and thereby generates the first matrix data of the input amount X which are data of the respective states of those components 26 to 34 and 35 to 45.

The second-matrix-data generation function 13 of the learning data generation section 11 assigns 0 or 1 to the state (i.e., conductive state or non-conductive state) of each of the power-distribution boards 53 to 60 when each of the circuit breakers 26 to 34 and disconnector 35 to 45 is in a predetermined state. In other words, the second-matrix-data generation function 13 expresses the state of each of the power-distribution boards 53 to 60 as 0 or 1, and thereby generates the second matrix data of the output amount Y which are data of the respective states of those components 26 to 34 and 35 to 45 in terms of conduction.

In the present embodiment, discrete values of 0 and 1 are outputted as output amount. However, by appropriately setting functions and parameters such as the activation function in the output layer, it is possible to classify them into multiple classes other than 0 and 1, and it is also possible to output continuous values.

The isolation management system 1 causes the multilayered neural network 10 to learn these listed matrix data as the learning data. The deep learning circuitry 9 constructs the neural network 10 which has completed learning, in such a manner that the correct answer rate of the output result becomes high. For instance, the deep learning circuitry 9 constructs the neural network 10 which has completed learning, in such a manner that the discrepancy between the output result and the answer (expected output) in the case of inputting verification data becomes small.

Next, a description will be given of a procedure for generating an isolation work plan by using the multilayered neural network 10 which has completed learning. First, designation of the power-distribution board 53 of the targeted area T is received as targeted area information by using the user interface 18. In the present embodiment, an instruction to turn off the power-distribution board 53 of the installation place T is inputted as the targeted area information.

Additionally, the state information of the power-distribution board 53 of the targeted area T and the state information of the circuit breakers 26 to 34 and the disconnectors 35 to 45 are outputted from the integrated database 2 to the deep learning circuitry 9. The circuit breakers 26 to 34 and the disconnectors 35 to 45 are connected as devices to the power-distribution board 53 and are components of this system. The deep learning circuitry 9 uses the neural network 10, which has been constructed on the basis of the input amount X and has completed learning, so as to extract such a combination pattern of the states of the circuit breakers 26 to 34 and the disconnectors 35 to 45 that the power distribution board 53 of the targeted area T is turned off.

In the present embodiment, patterns of ON/OFF combinations of the circuit breakers 26 to 34 and the disconnectors 35 to 45 regarding the power distribution board 53 of the targeted area T are inputted as the input amount X to the neural network 10 which has completed learning. The deep learning circuitry 9 extracts such a pattern of ON/OFF combinations of the circuit breakers 26 to 34 and the disconnectors 35 to 45 that the power distribution board 53 of the target place T is tuned off, from all the states of the power-distribution boards 53 to 60.

When there is no operation procedure (i.e., when the worker at the site may start from any operation) as to the actual operation of the circuit breakers 26 to 34 and the disconnectors 35 to 45, it is possible to generate the isolation work plan on the basis of the extracted pattern of the ON/OFF combination.

Conversely, when there is a specific operation procedure (i.e., when the worker at the site has to start from a specific operation), the deep learning circuitry 9 enters the extracted pattern of ON/OFF combination (i.e., specific pattern) and rules and logic of the operation procedure into the operation-procedure extracting section 16. The operation-procedure extracting section 16 extracts the ON/OFF operation procedure of the circuit breakers 26 to 34 and the disconnectors 35 to 45 which matches the rules and logic, and outputs the extracted operation procedure. The rules and logic of the operation procedure can be entered on the user interface 18 or be stored in the integrated database 2 in advance.

The operation-procedure extracting section 16 inputs respective patterns of ON/OFF combinations of the circuit breakers 26 to 34 and the disconnectors 35 to 45, which can be taken in the course of operation of the isolation work, as the input amount X into the neural network 10 which has completed learning. The operation-procedure extracting section 16 outputs patterns of respective states of the power-distribution boards 53 to 60 as the output amount Y. In this processing, the operation-procedure extracting section 16 narrows down the input amount X and the output amount Y on the basis of the inputted rules or logic of the operation procedure, and then finally extracts (lists) the operation procedure in which the power-distribution board 53 of the targeted area T is brought into the target state.

Further, it is assumed that plural proposed plans (choices) exist in the extracted patterns (list) and the operation procedure. Thus, by using arbitrary information such as environmental information in the plant, the optimum proposed plan is extracted from the plural proposed plans by using the reinforcement learning section 15. The reinforcement learning section 15 uses reinforcement learning which is a type of machine learning. In the reinforcement learning, an agent, which is a substantial body of the learning such as a software agent, learns to maximize the value in a given environment.

When a state Sₜ at the time t of the environment is given, the agent perceives such state Sₜ of the environment and selects an action (or a set of actions) Aₜ at the time t. With such action Aₜ, the agent obtains numerical reward rₜ₊₁ and the state of the environment transits from state Sₜ to state Sₜ₊₁. With the reinforcement learning, the agent selects a set of actions to maximize an amount of the total reward obtained (or expected to be obtained) in the course of such set of actions. Such total reward obtained (or expected to be obtained) in the course of a set of actions is referred to as a value and such value is formulated as a value function Q(s, a), where s represents a state of the environment and a represents an action to be possibly taken or selected. In the present embodiment, deep reinforcement learning which expresses the value function by the multilayer neural network 10 is used.

The extracted pattern and the extracted operation procedure are inputted into the reinforcement learning section 15. In addition, the arbitrary information including the environmental information stored in the integrated database 2 is inputted to the reinforcement learning section 15. For instance, radiation dose, temperature, humidity, position information (coordinates) for each area in the power plant and/or moving distance of a worker are inputted. Furthermore, these information items are defined by rewards. For instance, when the environment of the area where the power-distribution board 53 of the targeted area T is arranged is indicated with radiation dose 1 pSv/h, temperature 25° C., humidity 30°, and movement distance 10 m, the rewards corresponding to these four parameter values are defined as −1 point, −1 point, −6 points, and −6 points, respectively.

For setting these rewards, an arbitrary function or conversion formula defined by the administrator can be used. For instance, the environment information is defined as a reward for each area where each component is arranged, such as the area where the circuit breakers 30 and 31 are arranged and the area where the disconnectors 35 and 36 are arranged.

The input amount X is set as the transition of the work area associated with the ON/OFF operation of the circuit breakers 26 to 34 and the disconnectors 35 to 45, which transition is at least one of information items related to the reward s, the inputted pattern, and the operation procedure. A value function is expressed by using the multilayered neural network 10. By using such a value function, the plan which has the highest value among the plural proposed plans is determined.

On the basis of the determined proposed plan, the plan generator 17 generates a work plan. This work plan may be a document composed of sentences and figures recognizable by an operator or data supporting the work. The work plan generated by the plan generator 17 is inputted to the verification section 5 of the plant simulator 3 before it is eventually outputted.

The verification section 5 verifies influence on the plant in the case of performing the isolation work in accordance with the work plan. For instance, in the evaluation system based on the simulator, verification is performed on the basis of physical models such as the circuit diagram or the system diagram. Further, it is verified whether or not a problem such as abnormality warning and an error in isolation work occurs in the case of performing the isolation work in accordance with the work plan. In this manner, it is possible to verify whether the work plan based on the specific pattern extracted by the deep learning circuitry 9 is appropriate or not, before actually performing the isolation work. When there is no problem in the work plan as the result of this verification, this work plan is outputted by the output section 20 of the user interface 18.

In the present embodiment as described above, it is possible to automatically generate an isolation work plan by combining the plant simulator 3 and the deep learning circuitry 9 which includes the multilayered neural network 10. In addition, as compared with the case where an isolation work plan is made by the simulator alone, the calculation cost can be suppressed. Further, by using the reinforcement learning section 15, it is possible to automatically devise the isolation work plan by which the isolation work can performed most efficiently.

In the present embodiment, feature amount of change patterns is acquired by the multilayered neural network 10 and a specific pattern is extracted on the basis of the feature amount. Thus, processing efficiency for extracting a specific pattern from plural change patterns can be improved.

Additionally, it is possible to shorten a time for extracting a specific pattern from plural change patterns by causing the multilayered neural network 10, which has completed learning, to extract the specific pattern.

Further, the learning data generation section 11 can generate a work plan which follows the isolation work performed in the past, by generating learning data on the basis of the past work plans stored in the integrated database 2. As a result, reliability of the work plan can be improved.

Moreover, the deep learning circuitry 9 can generate the learning data which correspond to respective types of components constituting the plant, by causing the multilayered neural network 10 to learn the learning data which include the first matrix data and the second matrix data. Thus, it is possible to build the multilayered neural network 10 suitable for isolation work in the plant.

The reinforcement learning section 15 can extract the most suitable pattern for isolation work by extracting the proposed plan with the highest value on the basis of the reward from respective plural proposed plans which are generated from plural specific patterns. Incidentally, the reinforcement learning section 15 includes a deep reinforcement learning function 15A as one option of the reinforcement learning, and this deep reinforcement learning function 15A uses a neural network.

Furthermore, the operation-procedure extracting section 16 can extract the operation procedure most suitable for the isolation work, by extracting the operation procedure of the isolation work on the basis of the extracted specific patterns.

The isolation management system 1 of the present embodiment includes hardware resources such as a CPU (Central Processing Unit), a ROM (Read Only Memory), a RAM (Random Access Memory), and a HDD (Hard Disc Drive), and is configured as a computer in which information processing by software is achieved with the use of the hardware resources by causing the CPU to execute various programs. Further, the isolation management method of the present embodiment is achieved by causing the computer to execute the various programs.

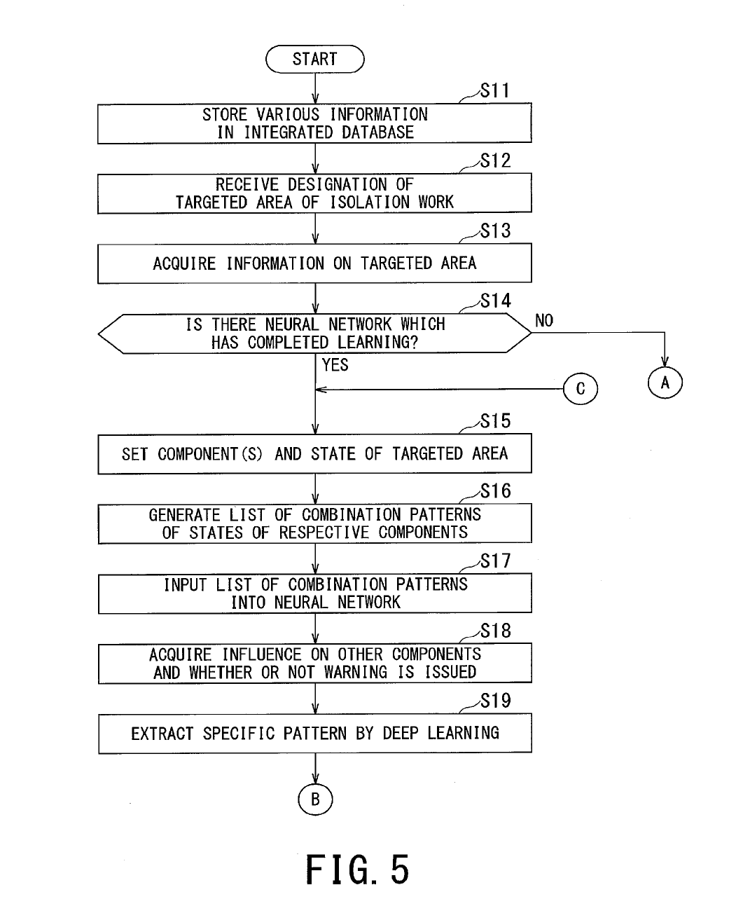

Next, a description will be given of the processing executed by the isolation management system 1 with reference to the flowcharts of FIG. 5 to FIG. 8.

As shown in FIG. 5, in the step S11 corresponding to the route R1 in FIG. 1, the integrated database 2 first stores various information including the design documents on the plant, the driving information, the personnel planning information, the environmental information, the construction information, the trouble information, and the past work plans.

In the next step S12 corresponding to the routes R2 and R3 in FIG. 1, the reception section 19 of the user interface 18 receives targeted area information defining the targeted area T of the isolation work on the basis of the input operation by the administrator. For instance, designation of the power-distribution board 53 of the targeted area T is received as the targeted area information.

In the next step S13 corresponding to the routes R6 and R11 in FIG. 1, the main controller 100 of the isolation management system 1 causes the data holding section 81 of the plant simulator 3 and the data holding section 82 of the deep learning circuitry 9 to acquire information on the power-distribution board 53 of the targeted area T from the integrated database 2. Specifically, the data holding sections 81 and 82 acquire information which is related to the power-distribution board 53 (component) of the targeted area T specified in the user interface 18 and is also information on the circuit breakers 26 to 34 and the disconnectors 35 to 45 in the vicinity of the power-distribution board 53. For instance, the data holding sections 81 and 82 acquire the ON/OFF state or opened/closed state of each of the power distribution boards and the circuit breakers 26 to 34, and the disconnectors 35 to 45.

In the next step S14 corresponding to the route R4 in FIG. 1, the main controller 100 determines whether there is a neural network 10 which has completed learning with respect to the targeted area specified by the user interface 18 or not. When there is not such a neural network 10 which has completed learning, the processing proceeds to the step S20 to be described below. Conversely, when there is a neural network 10 which has completed learning, the processing proceeds to the step S15.

In the step S15 corresponding to the route R6 in FIG. 1, the main controller 100 sets the component(s) and state of the targeted area T in the deep learning circuitry 9 on the basis of the information acquired from the integrated database 2. For instance, the main controller 100 sets the power-distribution board 53 to be OFF.

In the next step S16, the main controller 100 generates a list of combination patterns of the states of the respective components related to the targeted area T on the basis of the information stored in the integrated database 2. For instance, the main controller 100 generates a list of combinations indicative of the respective ON/OFF states of the circuit breakers 26 to 34 and the disconnectors 35 to 45 which are directly or indirectly connected to the power distribution board 53 of the targeted area T.

In the next step S17 corresponding to the route R7 in FIG. 1, the main controller 100 outputs the generated list of the combination patterns of the respective states of the components regarding the targeted area T to the neural network 10, which has completed learning and belongs to the deep learning circuitry 9.

In the next step S18, the neural network 10 acquires the state of each of the components of the targeted area T (i.e., components relevant to the targeted area T), and acquires the analysis result such as the influence on other components (i.e., components irrelevant to the targeted area T) and whether or not warning is issued.

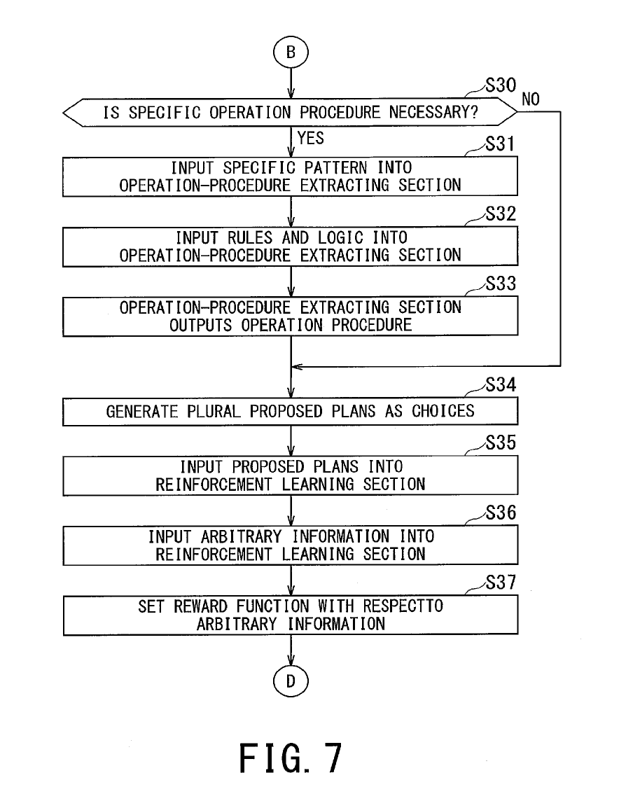

In the next step S19 corresponding to the route R20 in FIG. 1, the main controller 100 extracts a specific state pattern of the respective components by the deep learning of the neural network 10, and causes the data holding section 82 to hold the extracted pattern. Specifically, the main controller 100 extracts such a pattern of combination of the respective states of the circuit breaker 26 to 34 and the disconnectors 35 to 45 that the power distribution board 53 of the targeted area T is caused to be turned off. Afterward, the processing proceeds to the step S30 in FIG. 7 to be described below.

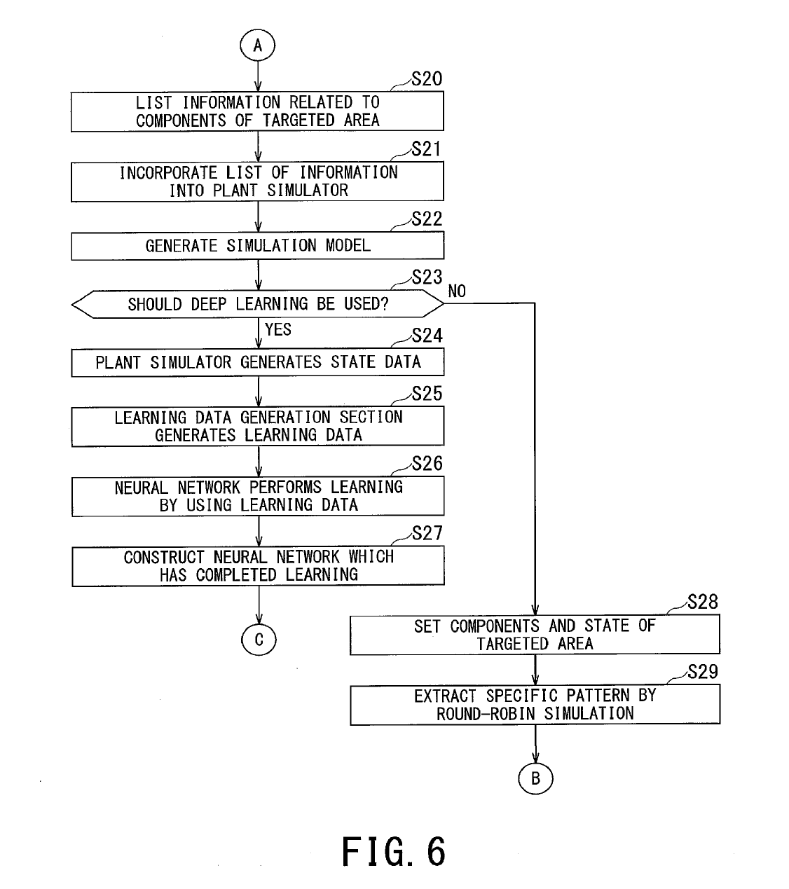

The step S20 in FIG. 6 is the processing to be performed immediately after the step S14 when there is not a neural network 10 which has completed learning in the step S14. In the step S20 corresponding to the route R8 in FIG. 1, the learning data generation section 11 lists various information items included in the information acquired from the integrated database 2 or acquires the information which has been already listed. Note that the above-described verb “list” means processing of picking up data or performing conversion, in the present embodiment.

In the next step S21 corresponding to the route R9 in FIG. 1, the analysis section 4 of the plant simulator 3 acquires the list of various information items.

In the next step S22 corresponding to the route R21 in FIG. 1, the analysis section 4 generates a simulation model of the power-distribution system 25 of the plant on the basis of the data held in the data holding section 81.

In the next step S23, the main controller 100 determines whether to use the deep learning. When the calculation amount (i.e., target value of determination) for extracting a specific pattern suitable for the isolation work is less than a predetermined threshold value, i.e., when processing can be performed by the round-robin simulation, the main controller 100 determines to not use the deep learning and advances the processing to the step S28 to be described below. Conversely, when the calculation amount (i.e., target value of determination) for extracting a specific pattern suitable for the isolation work is equal to or larger than the predetermined threshold value, i.e., when the processing with the use of the deep learning is necessary, the main controller 100 determines to use the deep learning and advances the processing to the step S24.

In the step S24 corresponding to the route R10 in FIG. 1, the analysis section 4 of the plant simulator 3 generates data indicative of the state of each component and transmits the generated data to the learning data generation section 11. For instance, the analysis section 4 generates data indicative of the conduction state of the power-distribution board 53 of the targeted area T in the case of changing the respective states of all the circuit breakers 26 to 34 and disconnectors 35 to 45.

In the next step S25, the learning data generation section 11 of the deep learning circuitry 9 generates the learning data. For instance, the learning data generation section 11 generates the first matrix data indicative of the respective states of the circuit breakers 26 to 34 and the disconnectors 35 to 45, and further generates the second matrix data indicative of the respective states of the power-distribution boards 53 to 60.

In the next step S26 corresponding to the route R5 in FIG. 1, the main controller 100 causes the multilayered neural network 10 of the deep learning circuitry 9 to perform learning in which the matrix data are treated as the learning data.

In the next step S27, the deep learning circuitry 9 constructs the neural network 10 which has completed learning, and returns the processing to the step S15 in FIG. 5.

The step S28 in FIG. 6 is the processing to be performed immediately after the step S23 when it is determined to not use the deep learning. In the step S28 corresponding to the route R11 in FIG. 1, the plant simulator 3 sets the components and state of the targeted area T in the simulation model of the analysis section 4.

In the next step S29, the round-robin simulation is performed and a specific pattern suitable for the isolation work is extracted, and then the processing proceeds to the step S30 in FIG. 7.

In the step S30 of FIG. 7, the main controller 100 determines whether a specific operation procedure (i.e., a specific pattern of operation which has been extracted and been held in the data holding section 81) is necessary for the actual operation of the circuit breakers 26 to 34 and the disconnectors 35 to 45 or not. When the specific operation procedure is unnecessary, the processing proceeds to the step S34 to be described below. Conversely, when the specific operation procedure is necessary, the processing proceeds to the step S31.

In the step S31 corresponding to the routes R12 and R13 in FIG. 1, the main controller 100 inputs the specific pattern held in the data holding sections 81 and 82 into the operation-procedure extracting section 16 of the deep learning circuitry 9.

In the next step S32 corresponding to the routes R12 and R13 in FIG. 1, the main controller 100 inputs the rules and logic of the operation procedure related to the actual operation of the circuit breakers 26 to 34 and the disconnectors 35 to 45 into the operation-procedure extracting section 16 of the deep learning circuitry 9.

In the next step S33, the operation-procedure extracting section 16 specifies and acquires the operation procedure which matches the rules and logic.

In the step S34, the main controller 100 causes the deep learning circuitry 9 to generate plural proposed plans as choices on the basis of the specific pattern and the operation procedure.

In the next step S35 corresponding to the route R15 in FIG. 1, the main controller 100 inputs the plural proposed plans as choices into the reinforcement learning section 15 of the deep learning circuitry 9.

In the next step S36 corresponding to the route R15 in FIG. 1, the main controller 100 inputs arbitrary information into the reinforcement learning section 15, which arbitrary information relates to the plant and includes the environment information acquired from the integrated database 2.

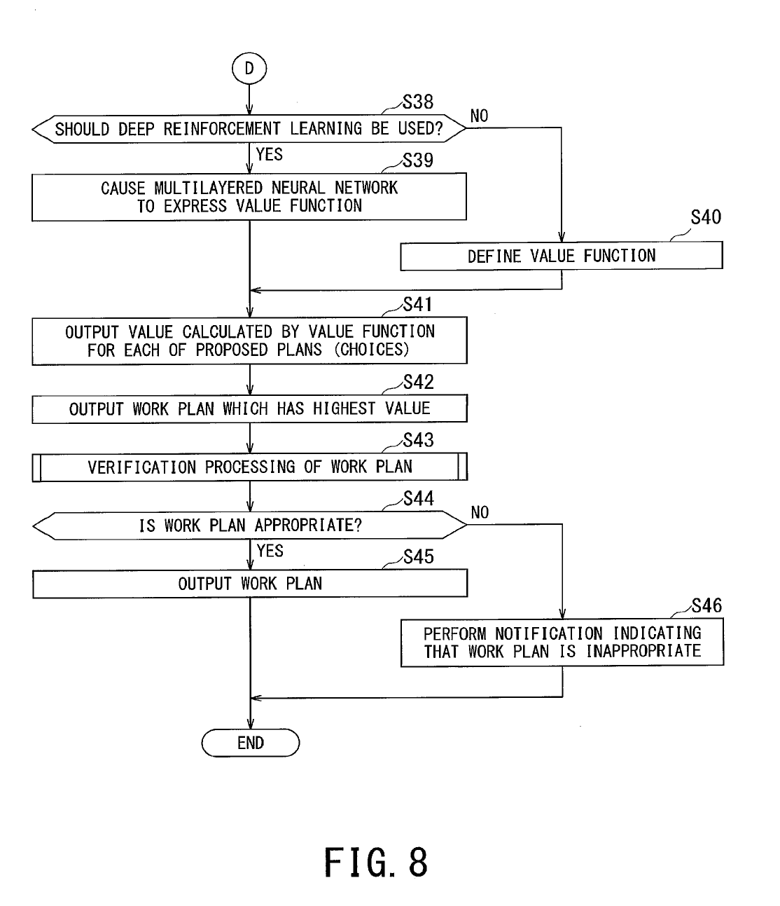

In the next step S37 corresponding to the route R14 in FIG. 1, the main controller 100 causes the reward setting section 14 of the deep learning circuitry 9 to set a reward with respect to the inputted arbitrary information on the plant, and then advances the processing to the step S38 in FIG. 8. The reward having been set by the reward setting section 14 is inputted to the reinforcement learning section 15, which corresponds to the route R23 in FIG. 1. Information on the operation procedure is also inputted to the reinforcement learning section 15, which corresponds to the route R24 in FIG. 1.

In the step S38 of FIG. 8, the main controller 100 determines whether the deep reinforcement learning should be used for extracting the optimum plan from the plural proposed plans or not. When the calculation amount (i.e., target value of determination) for extracting the optimum proposed plan is less than the predetermined threshold, the main controller 100 determines that the deep reinforcement learning is unnecessary, then defines a value function by methods such as Monte Carlo Method or Q-learning in the step S40, and then advances the processing to the step S41.

Conversely, when the calculation amount (i.e., target value of determination) for extracting the optimum proposed plan is equal to or more than the predetermined threshold, i.e., when it is necessary to perform the processing of extracting the optimum proposed plan by using the deep reinforcement learning, the main controller 100 determines to use the deep reinforcement learning, then causes the multilayered neural network 10 to express a value function in the step S39, and then advances the processing to the step S41.

In the step S41 corresponding to the route R16 in FIG. 1, the main controller 100 causes the reinforcement learning section 15 of the deep learning circuitry 9 to specify a value calculated by the value function for each of the plural proposed plans (i.e., choices), and outputs the information on the specified value to the plan generator 17.

In the next step S42 corresponding to the route R17 in FIG. 1, the plan generator 17 generates a work plan on the basis of the specified proposed plan which has the highest value, and outputs the generated work plan to the verification section 5 of the plant simulator 3.

In the next step S43 corresponding to the route R22 in FIG. 1, the verification section 5 performs processing of verifying the influence on the plant in the case of performing the isolation work in accordance with the work plan, on the basis of the data held in the data holding section 81.

In the next step S44 corresponding to the route R18 in FIG. 1, the verification section 5 determines whether the work plan is appropriate or not. When the work plan is determined to be appropriate, the processing proceeds to the step S45 in which this work plan is outputted by the output section 20 of the user interface 18 via the plan generator 17 as indicated by the route R19 in FIG. 1, and then the entire processing is completed. Conversely, when the work plan is determined to be inappropriate, the output section 20 of the user interface 18 performs notification indicating that the work plan is inappropriate, and then the entire processing is completed.

In the present embodiment, the determination of one value (i.e., target value) using a reference value (i.e., threshold value) may be determination of whether the target value is equal to or larger than the reference value or not.

Additionally or alternatively, the determination of the target value using the reference value may be determination of whether the target value exceeds the reference value or not.

Additionally or alternatively, the determination of the target value using the reference value may be determination of whether the target value is equal to or smaller than the reference value or not.

Additionally or alternatively, the determination of the one value using the reference value may be determination of whether the target value is smaller than the reference value or not.

Additionally or alternatively, the reference value is not necessarily fixed and the reference value may be changed. Thus, a predetermined range of values may be used instead of the reference value, and the determination of the target value may be determination of whether the target value is within the predetermined range or not.

Although a mode in which each step is executed in series is illustrated in the flowcharts of the present embodiment, the execution order of the respective steps is not necessarily fixed and the execution order of part of the steps may be changed. Additionally, some steps may be executed in parallel with another step.

The isolation management system 1 of the present embodiment includes a storage device such as a ROM (Read Only Memory) and a RAM (Random Access Memory), an external storage device such as a HDD (Hard Disk Drive) and an SSD (Solid State Drive), a display device such as a display, an input device such as a mouse and a keyboard, a communication interface, and a control device which has a highly integrated processor such as a special-purpose chip, an FPGA (Field Programmable Gate Array), a GPU (Graphics Processing Unit), and a CPU (Central Processing Unit). The isolation management system 1 can be achieved by hardware configuration with the use of a normal computer.

Note that each program executed in the isolation management system 1 of the present embodiment is provided by being incorporated in a memory such as a ROM in advance. Additionally or alternatively, each program may be provided by being stored as a file of installable or executable format in a non-transitory computer-readable storage medium such as a CD-ROM, a CD-R, a memory card, a DVD, and a flexible disk (FD).

In addition, each program executed in the isolation management system 1 may be stored on a computer connected to a network such as the Internet and be provided by being downloaded via a network. Further, the isolation management system 1 can also be configured by interconnecting and combining separate modules, which independently exhibit respective functions of the components, via a network or a dedicated line.

Although remodeling work of the power-distribution system 25 constituting a part of the power supply system in the plant is exemplified in the present embodiment, the present invention may be applied in order to generate a work plan of isolation other than the power distribution system.

Note that the deep learning circuitry 9 may extract the pattern having the smallest change occurring in other places as a specific pattern. In this manner, it is possible to extract the pattern which has the least influence on other components (i.e., components irrelevant to the targeted area T) and is the most suitable for the isolation work.

According to the above-described embodiments, it is possible to efficiently generate a work plan most suitable for isolation work by including (a) an analyzer configured to analyze patterns of the changing state occurring in components at other locations in the case of changing the state of a component related to a designated targeted area and (b) deep learning circuitry configured to extract a specific pattern from plural patterns of the changing state analyzed by the analyzer on the basis of deep learning.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An isolation management system comprising:
a database configured to store information which relates to a plant constructed with a plurality of components, the information comprising a relationship between the plurality of components;
a receiver configured to receive a targeted area information defining a targeted area in the plant;
an analyzer configured to analyze a plurality of patterns of respective states of the plurality of components in connection with a changing state of at least one of the plurality of components in the targeted area, based on the information stored in the database;
deep learning circuitry configured to extract at least one specific pattern from the plurality of patterns analyzed by the analyzer as an extraction pattern;
a plan generator configured to generate a work plan based on the extraction pattern; and
an output interface configured to output the work plan generated by the plan generator.

2. The isolation management system according to claim 1, further comprising a verifier configured to verify the pattern of respective states in the components outside of the targeted area in connection with the changing state of each component in the targeted area in accordance with the work plan.

3. The isolation management system according to claim 1,
wherein the deep learning circuitry includes an intermediate layer comprising a multilayered neural network and is configured to acquire feature amount of each of the plurality of patterns; and
the deep learning circuitry is further configured to extract the extraction pattern depending on the feature amount of each of the plurality of patterns.

4. The isolation management system according to claim 3,
wherein the deep learning circuitry includes a learning data generator configured to generate learning data configured to construct the multilayered neural network.

5. The isolation management system according to claim 4,
wherein the database is configured to store information on at least one past work plan; and
the learning data generator is configured to generate the learning data based on the past work plan stored in the database.

6. The isolation management system according to claim 4,
wherein the plurality of components comprises a predetermined first type component and a second type component connected to the first type component;
the learning data generator is configured to generate first matrix data, in which a state of the first type component analyzed by the analyzer is treated as input amount, and second matrix data, in which a state of the second type component analyzed by the analyzer is treated as output amount; and
the deep learning circuitry is configured to cause the multilayered neural network to learn the learning data which include the first matrix data and the second matrix data.

7. The isolation management system according to claim 3,
wherein the deep learning circuitry is configured to
set a reward with respect to the information stored in the database,
extract a plurality of specific patterns from the plurality of patterns analyzed by the analyzer, as a plurality of extraction patterns, and
extract a pattern having a highest value of the reward among the plurality of extraction patterns.

8. The isolation management system according to claim 1,
wherein the deep learning circuitry is configured to extract an operation procedure of the isolation work based on the extraction pattern; and
the plan generator is configured to generate the work plan based on the operation procedure extracted by the deep learning circuitry.

9. The isolation management system according to claim 1,
wherein the analyzer is configured to perform at least one of an analog-circuit analysis, a logic-circuit analysis, and a route-search analysis.

10. An isolation management method comprising:
storing information, which relates to a plant constructed with a plurality of components and defines relationship between the plurality of components, in a database;
receiving a targeted area information defining a targeted area in the plant;
analyzing a plurality of patterns of respective states of the plurality of the components in connection with a changing state of at least one of the plurality of components in the targeted area, based on the information stored in the database;
extracting a specific pattern from the plurality of patterns analyzed by the analyzer, as an extraction pattern;
generating a work plan based on the extraction pattern; and
outputting the work plan.
